(19) United States
(12) Patent Application Publication
(10) Pub. No.: US 2012/0124749 A1
(43) Pub. Date: May 24, 2012

(54) Meditation seating cushion

(76) Inventor: Clyde McClain Lewman, Yachats, OR (US)

(21) Appl. No.: 13/136,629

(22) Filed: Aug. 4, 2011

(51) Int. Cl. B68G 5/00

(52) U.S. Cl. 5/653

(57) ABSTRACT

A meditation seating cushion. The seating cushion may comprise a first cushion portion, a second cushion portion separate from the first cushion portion, and a strap connecting the first and second cushion portions together. A single seating cushion portion has a substantially planar bottom surface and a substantially semi-cylindrical top surface. The cushion portions are used for disposition on a support surface such as a floor or mat, each cushion portion being underneath one of the user's buttocks, for seating the user so as to avoid imposing stress on that region of the user's bottom including the anus, perineum, and vagina or scrotum.

### FIELD OF THE INVENTION

The present invention relates to a seating cushion, particularly for use in meditative activities, such as Tai Chi and yoga.

### BACKGROUND

For many if not most forms of meditation, it is important to be in a relaxed, comfortable seated position. Typically, for sitting, a single flat support cushion is utilized, and there may be an additional pillow placed on top of this cushion. The pillow or cushion, or combination, is used to provide a seating surface at a desired elevation that accommodates or receives at least the majority of the surface area defined by the user's buttocks or backside.

It is an objective of the present invention to provide an improved meditation seating cushion.

### SUMMARY

A meditation seating cushion is disclosed herein. The seating cushion comprises a first cushion portion, a second cushion portion separate from the first cushion portion, and a strap connecting the first and second cushion portions together.

Preferably, the cushion portions are substantially identical in size and shape. For convenience, the following summary will refer to only one of them.

Preferably, the cushion portion has a substantially planar bottom surface.

The cushion portion has one or more edges defining a perimeter thereof, and a top surface opposed to the bottom surface. For reference purposes, a first reference plane may be defined which is perpendicular to the bottom surface, and which therefore intersects the top surface, and which also intersects the perimeter at left and right edge-points thereof. The firsts reference plane defines a first reference line lying in the plane of the bottom surface.

Preferably, the top surface has an elevation that varies relative to the bottom surface. More particularly, the elevation varies in the first reference plane so as to have a left edge value defined at the left edge-point, a right edge value defined at the right edge-point, and a peak value defined at an intermediate point on the first reference line lying between the left and right edge-points, and so as to decrease monotonically from the peak value to the left and right edge values.

Preferably, the minimum difference between the peak value and either of the left and right edge values is about 1.5″

Preferably, the top surface has a substantially constant radius of curvature in the first reference plane, meaning that it substantially follows the arc of a circle.

For reference, a second reference plane may be defined that is perpendicular to the first reference plane and which intersects the perimeter at respective fore and aft edge-points thereof. The second reference plane defines a second reference line lying in the plane of the bottom surface, and the distance between the fore and aft edge-points defines a length of the cushion portion. Also for reference, any number of third reference planes may be defined which are parallel to the first reference plane and which intersect the second reference line at intermediate points thereof which are spaced from the fore and aft edge-points at least an amount equal to 25% of the length. Each third reference plane intersects the perimeter at corresponding left and right edge-points thereof, and defines a corresponding third reference line lying in the plane of the bottom surface.

Preferably, the elevation varies in any of the third reference planes so as to have a respective left edge value defined at the respective left edge-point, a respective right edge value at the respective right edge-point, and a respective peak value defined at a respective intermediate point on the respective third reference line lying between the respective left and right edge-points, and so as to decrease monotonically from the respective peak value to the respective left and right edge values.

Preferably, for any of said third reference planes, the minimum difference between the respective peak value and either of the respective left and right edge values is 1.5″.

Preferably, the top surface has a substantially constant radius of curvature that is substantially the same in each of the third reference planes.

Preferably, the cushion portion has bilateral symmetry.

A method for seating a person according to the invention is also disclosed. In basic form, the method includes providing a first cushion portion and a second cushion portion separate from the first cushion portion, disposing the first cushion portion under one of the buttocks of the person, and disposing the second cushion under the other buttocks of the person.

Depending on the widths of the cushion portions, it may be preferable to space the first and second cushion portions apart from one another.

Preferably, the first and second cushion portions each have, respectively, a substantially planar bottom surface, and the bottom surfaces are both disposed on a horizontal support surface, such as a floor or mat.

Preferably, the cushion portions are substantially identical in size and shape. With the seated person defining a plane of bilateral symmetry, the two cushion portions are preferably disposed so that they are symmetrically disposed about this plane.

Preferably, the cushion portions each have a substantially straight line of maximum elevation, and the cushion portions are disposed so that infinitely extending lines collinear with these lines of maximum elevation define an angle therebetween of between about 10 and 35 degrees, and intersect behind the seated person.

Preferably, the cushion portions are connected by a strap, so that the seating cushion can be manually carried with the aid of the strap.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is an isometric view of a meditation seating cushion having two cushion portions according to the present invention.

FIG. 2 is a front elevation of one of the cushion portions of the meditation seating cushion of FIG. 1.

FIG. 3 is a plan view of the cushion portion of FIG. 2.

FIG. 4 is a first isometric view of the cushion portion of FIG. 2.

FIG. 5 is a second isometric view of the cushion portion of FIG. 2, corresponding to FIG. 4.

FIG. 6 is an isometric view of a first alternative embodiment of a seating cushion according to the present invention.

FIG. 7 is an isometric view of a second alternative embodiment of a seating cushion according to the present invention.

FIG. 8 is an isometric view of a third alternative embodiment of a seating cushion according to the present invention.

FIG. 9 is an isometric view of a user seated on the meditation seating cushion of FIG. 1.

FIG. 10 is a plan view of the seating cushion of FIG. 8.

### DETAILED DESCRIPTION OF A PREFERRED EMBODIMENT

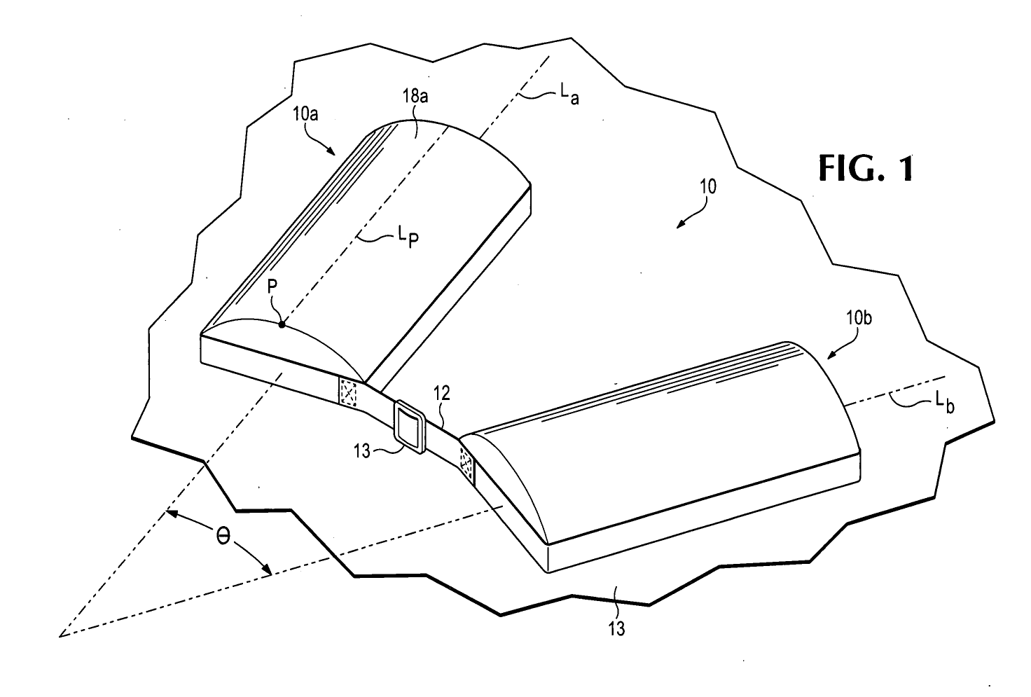

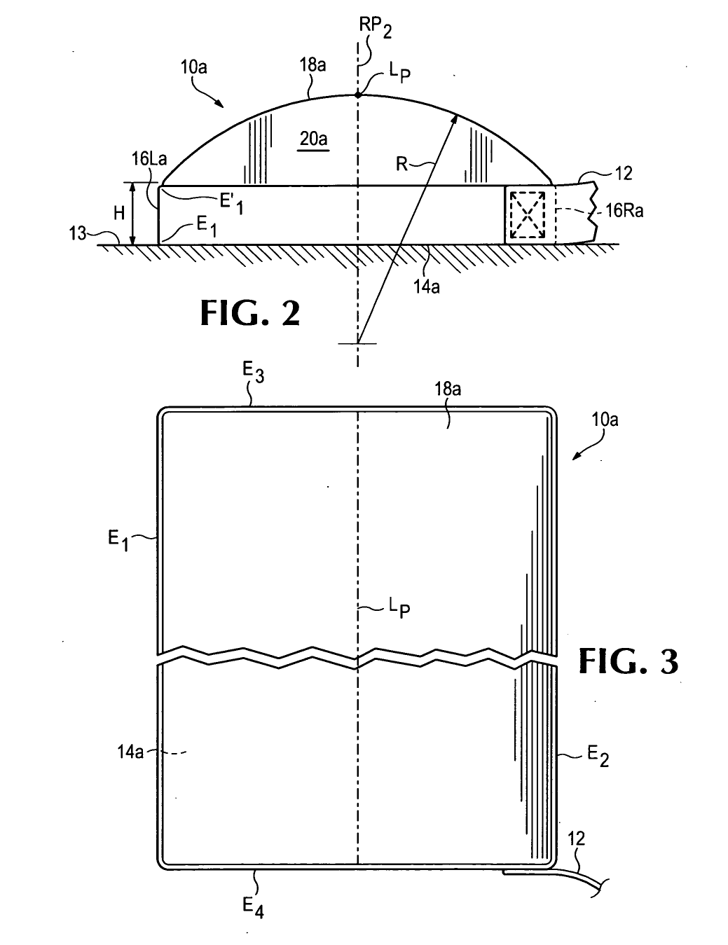

FIG. 1 shows a preferred meditation seating cushion 10 according to the present invention. One outstanding feature of the cushion 10 is that it comprises two separately positionable cushion portions 10a, 10b, one of which is also shown in FIG. 2, that are connected to one another by a strap 12.

FIG. 2 shows one of the cushion portions 10a in elevation, and shows particularly a preferred, substantially semi-cylindrical shape or configuration of the cushion portions.

Each cushion portion 10a, 10b has a substantially planar bottom surface 14, referenced more specifically in FIG. 2 as 14a for the cushion portion 10a, for resting on a likewise substantially planar support surface 13.

Each cushion portion 10a, 10b may have sides 16, particularly in this example right and left sides 16R and 16L (referenced more particularly as 16Ra and 16La for the cushion portion 10a in FIG. 2). Such sides may stand upright relative to the bottom surface 14 the same height “H,” and be oriented substantially perpendicular to the associated bottom surface 14. Alternatively, the sides may stand at other angles to the bottom surface 14, they may stand at different heights, and each may independently be reduced in height to the point of vanishing, in which case the side(s) cease to exist (i.e., they collapse to the point of being the same as the corresponding edge (e.g., edge “E₁′” of the top surface 18a collapses to meet edge “E₁” of the bottom surface 14a).

FIG. 3 shows the cushion portion 10a in plan, where it is assumed that if the cushion portion has sides 16, they stand upright and therefore appear coincident with the outermost edges of the bottom surface 14a in plan view. The bottom surface 14a in this example has four outermost edges E₁, E₂, E₃, and E₄. These edges define a perimeter of the bottom surface.

Each cushion portion 10a, 10b has an opposed top surface, referenced as 18, and referenced more specifically in FIG. 2 as 18a for the cushion portion 10a.

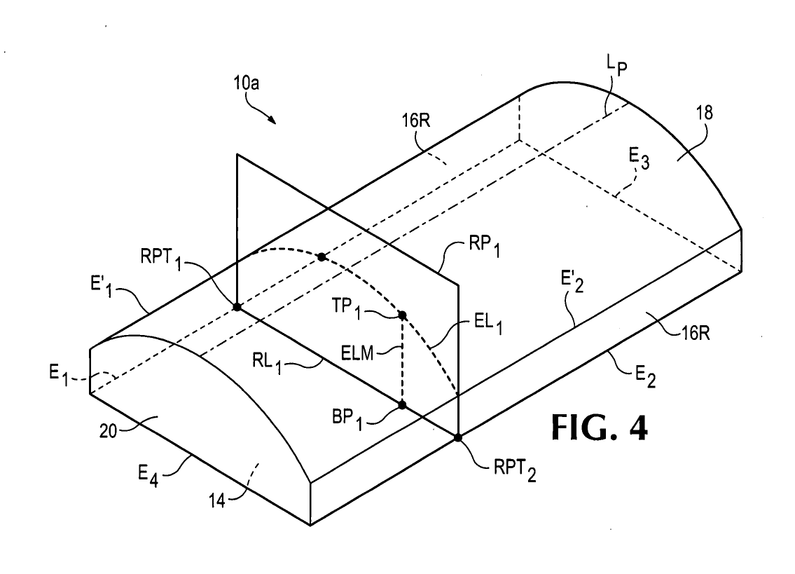

FIG. 4 shows the top surface 18a, bottom surface 14a, and (optional) side surfaces 16La and 16Ra of the cushion portion 10a in isometric view. The side surfaces as shown have (left and right side) edges E₁′ and E₂′, corresponding to the edges E₁ and E₂. The top surface extends so as to terminate at the edges E₁′ and E₂′, and so will appear to terminate at the edges E₁ and E₂ in the plan view of FIG. 2.

With continued reference to FIG. 4, the top surface 18 varies in elevation, relative to the plane of the bottom surface 14. The elevation is highest along the ridge line Lₚ, and decreases monotonically with distance away from the line Lₚ, on either side of the line (toward either edge E₁ or E₂). The elevation can be defined in any cross-sectional plane, such as the reference plane RP₁ in which the top surface traces the curve EL₁ (shown dotted). The plane RP₁ defines a reference line RL₁ which is the line of intersection of the plane RP₁ and the bottom surface 14. The reference line RL₁ has, as its end-points, points RPT₁ and RPT₂, which are points lying on the edges E₁ and E₂ respectively.

The elevation of the top surface along the curve EL₁ is determined, for any particular point BP₁ on the line RL₁ as the distance from the point BP₁ to the top surface 18 (which is at the point TP₁) along an elevation measurement line ELM that is perpendicular to the bottom surface 14.

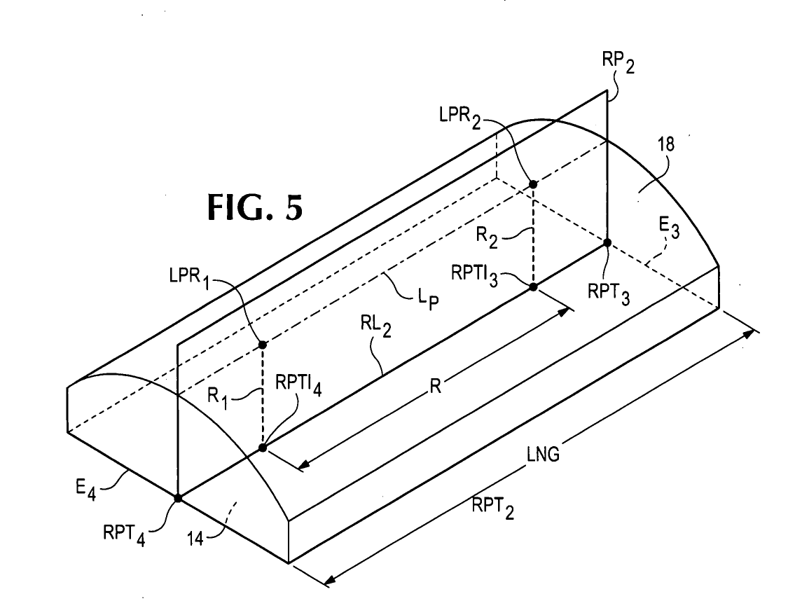

By comparison with FIG. 4, FIG. 5 shows the same cushion portion with a reference plane RP₂ that is perpendicular to the reference plane RP₁ and to the bottom surface 14. The plane RP₂ defines a reference line RL₂ which is the line of intersection of the plane RP₂ and the bottom surface 14. The reference line RL₂ has, as its end-points, points RPT₃ and RPT₄, which are points lying on the (fore and aft) edges E₃ and E₄ respectively.

The elevation of the top surface 18 can be defined in the reference plane RP₂ in which the top surface traces the line Lₚ, which represents the peak or highest elevation of the top surface relative to the bottom surface 14. In this example, (1) there is a line of peak elevation, which is (1) straight; (2) extends parallel to the bottom surface 14; (3) extends perpendicular to the plane RP₁ (FIG. 4); and (4) extends along the entirety of the length “LNG” of the cushion portion. None of these particulars are requirements, however. According to the invention there may be a plane of peak elevation rather than a line, and if there is a line, it can be curved, and there is a line and it is straight, it need not be parallel to the bottom surface, or be perpendicular to the plane RP₁ or extend the entire length of the cushion portion.

As further reference in connection with FIG. 5, there are two intermediate reference points RPTI₃ and RPTI₄ associated with the edges E₃ and E₄ respectively. The point RPTI₃ is spaced from the point RPT₃ of the edge E₃ by an amount A=25% of the length LNG, and the point RPTI₄ is likewise spaced from the point RPT₄ of the edge E₄ by the same amount. The points RPTI₃ and RPTI₄ establish a region “R” bounded by lines R₁ and R₂. The lines R₁ and R₂ are perpendicular to the bottom surface 14, extend respectively from the points RPTI₃ and RPTI₄, and respectively intersect the top surface 18 at points LPR₁ and LPR₂. In this example these latter points lie on the line Lₚ. More generally (but not most generally), for any plane that is parallel to the reference plane RP₁ (FIG. 4) and is within the region R, the peak elevation of the top surface, defined for that plane, is the same, and is contiguous across all such planes.

The parameter A may be other than 25%. In particular, it may be as low as zero, corresponding to the line (or plane) of maximum elevation being sustained over substantially the entire length of the cushion portion. Preferably, 25% is the maximum value of the parameter A, corresponding to sustaining the maximum elevation over at least half the length of the cushion portion.

According to the invention, for any plane RP parallel to the reference plane RP₁ (FIG. 4), the elevation of the top surface will vary monotonically upward (i.e., it is ever increasing) from a first minimum at the edge E₁ (or E₁′) to a line or plane in which the elevation has reached a maximum, and then vary monotonically downward (i.e. it is ever decreasing) from the maximum elevation to a second minimum, which may be the same as or different from the first minimum, at the edge E₂ (or E₂′).

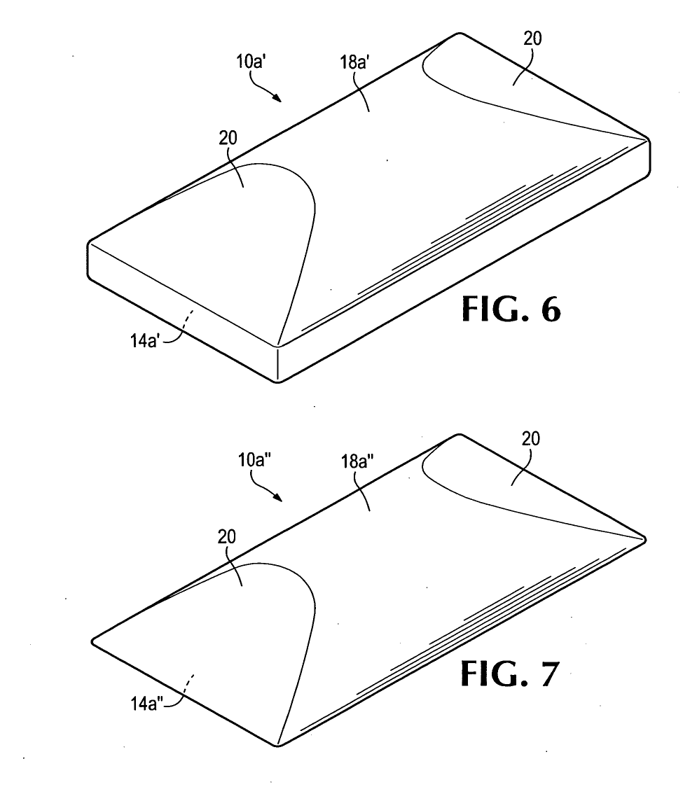

Returning to FIG. 2, each cushion portion 10a, 10b also has end surfaces 20, referred to more specifically as 20a for the cushion portion 10a as shown in FIG. 2. The end surfaces are preferably substantially planar, and may be perpendicular to the associated bottom surface 14, as shown in FIG. 4, or at an acute angle thereto, as shown in FIG. 6 (cushion portion, bottom surface and top surface respectively referenced as 10a′, 14a′ and 18a′), and FIG. 7 shows a variation without sides (cushion portion, bottom surface and top surface respectively referenced as 10a″, 14a″ and 18a″). The end surfaces 20 may have other configurations and orientations as desired.

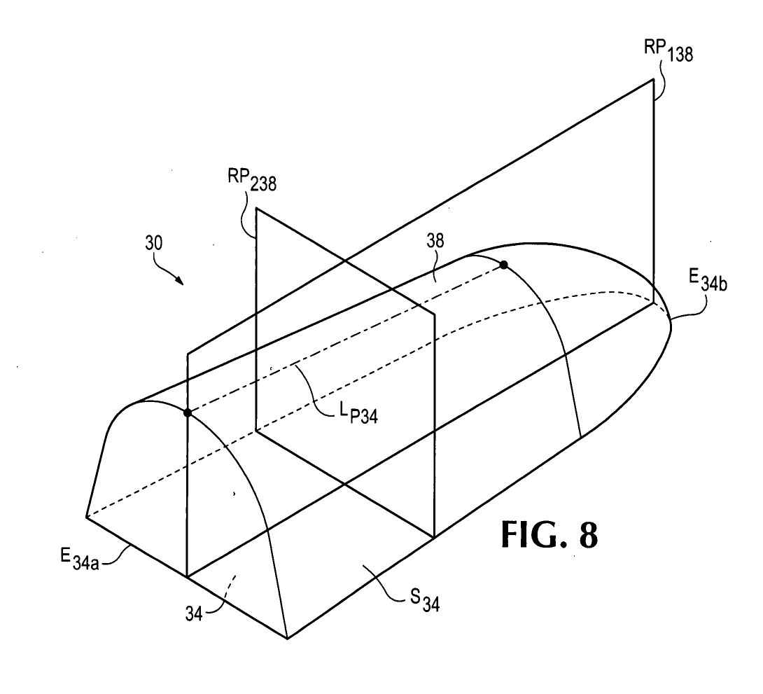

FIG. 8 shows an alternative configuration of a cushion portion than is shown in FIGS. 1-7, here referenced as 30. This example generalizes the previous embodiments somewhat. Here there is a planar bottom surface 34 having edges E₃₄ₐ and E_{34b}, sides S₃₄ (only one being visible) that is roughly triangularly shaped, and a top surface 38 having a line L_{P34} of peak elevation that slopes relative to the bottom surface. The cushion portion is bilaterally symmetric about a plane RP₁₃₈ and the line LP₃₄ lies in this plane.

The sides S₃₄ can be distinguished from the top surface 38 in that they are not curved. The top surface is curved, preferably in such manner that, in any reference plane analogous to the plane RP₁ of FIG. 4, such as the reference plane RP₂₃₈ which is one of any number of planes perpendicular to both the bottom surface 34 and the reference plane RP₁₃₈, the curvature of the top surface is circular, i.e., it has a constant radius of curvature.

It is of course possible for the radius of curvature to be the same for all such planes, defining a semi-cylindrical shape, even though the line of peak elevation LP₃₈ is not parallel to the bottom surface 34; however, the example particularly contemplates that the curvature of the top surface within different planes parallel to the plane RP₂₃₈ are different.

It should be noted that the curvatures defined by the top surface of cushion portions according to the invention can be monotonically varying in ways other than circular arcs. For example, a curvature may be defined by portions of an ellipse, hyperbola, exponential or sinusoid, just to name a few of the mathematically standardized curvatures; and the curvatures utilized in the present invention need not be limited to such standardized curvatures.

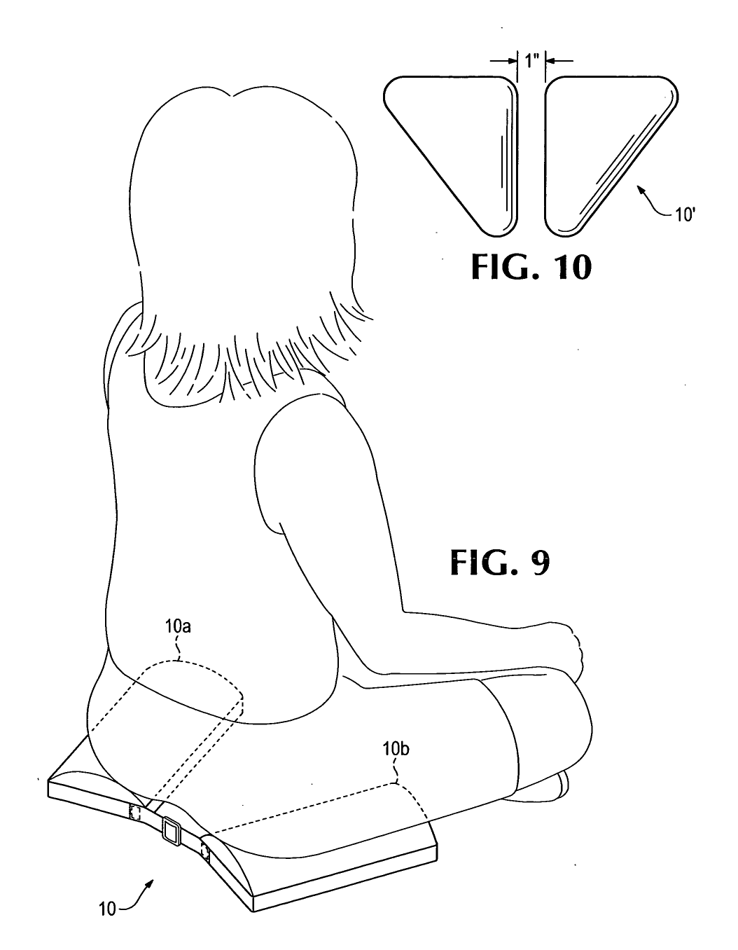

FIG. 9 shows a user seated on the cushion 10 in the preferred configuration of deployment. Each cushion portion is disposed underneath, and is used as support for, one of the user's buttocks. Preferably, the cushion portions are substantially identical in size and shape, to avoid introducing an imbalance in the seating surface provided to each of the user's buttocks. Also assisting in this regard, the cushion portions are preferably each symmetrical, i.e., each possessing its own plane of bilateral symmetry, as is the case for all of the examples discussed above. This assists in providing for maximum comfort, by helping the user avoid forces caused by imbalance.

Returning to FIG. 1, it has been found that it provides for superior comfort to arrange the cushion portions so that the lines of maximum elevation, or if there are planes of maximum elevation, elongate axes corresponding to these planes, are angled with respect to each other, preferably by an angle (θ) between about 10-35 degrees, rather than being parallel (θ=0). In the case where the cushion portions are substantially rectangular in plan (such as in the embodiment shown), so that the line of maximum elevation of a cushion portion will be parallel to its left and right side edges, this also ensures that, somewhere along the lengths of the two cushion portions, there will be a void space “V” as noted in FIG. 4.

Returning to FIG. 8, the user sits on the cushion portions so that the void space V aligns substantially with that general region of the user's bottom that includes the anus, perineum, and vagina or scrotum, and provides clearance for this region relative to the support surface, so that substantially none of the user's weight is borne by this region.

More particularly, the user is preferably seated so that his or her plane of bilateral symmetry, or centerline, is symmetrically disposed over the void space V, which preferably extends at least ½″ on either side.

It is not necessarily a requirement to space the cushion portions apart to effectively create a void space serving the purpose indicated above. Consider two cushion portions that can be identified as being “left” and “right” relative to the user, each being bilaterally symmetrical, each having a line (as opposed to a plane) of peak elevation and the two cushion portions being disposed side-by-side without any gap between them, the two lines of peak elevation being parallel.

If the cushion portions are each X″ wide, the horizontal distance between the line of peak elevation of the left cushion and the line of peak elevation of the right cushion will be X″, each being spaced λ/2″ from the user's centerline. Mid-way between this X″ span will be the minimum elevation, which could be substantially zero if there the cushion portions have no sides. If the elevation falls off sufficiently over this X″ span, it will effectively function as a void space. Preferably, to allow for this possibility, X is no greater than 7.5″, is preferably in the range of 5-7″, and is more preferably in the range 5.5-6.5″, with 6″ being generally about optimum; and the maximum elevation of the top surface of a given cushion portion is at least 1.5″ greater than the highest minimum elevation defined by the cushion portion.

The cushion portions 10a, 10b can be deployed so that they define, relative to each other in the manner described above, other angles than those in the aforedescribed preferred range, including an angle of zero. If the left and right edges of the cushion portions are parallel under this circumstance, the cushion portions are preferably spaced apart by at least 1″. An example is seen in FIG. 10, showing the seating cushion 30 of FIG. 8 in plan view.

The cushion portions 10a, 10b and 30 are intended to function as cushions or pillows, and therefore provide a substantial degree of mechanical compliance as is typical for articles of this type. The aforedescribed side, top, bottom and end surfaces are typically formed of a textile material, stitched or otherwise bonded together to form an enclosure having the configuration shown. Inside this enclosure is a cushion filling material, or stuffing, which may be of any standard type, or any type desired. Two common cushion filling materials are down and open-cell foam. For meditation cushions, buckwheat hulls or kapok fibers are often used. Because the cushion portions 10a, 10b are compliant and filled with stuffing material, the aforedescribed shapes of the configurations described above are not intended to be precise. It should also be understood that the shapes are being described (and claimed) herein for the cushion and cushion portions unstressed by any load, it being recognized that any compliant object can be forced to adopt shapes that it would not otherwise have. In addition, the use of the term “substantially,” in connection with specifying the cushion and cushion portions, reflects inherent limitations on the precision of specifying the shapes and sizes of stuffed articles, as well as on the precision afforded in the manufacture of such articles.

For purposes of definition, a “cushion” or “cushion portion” as those terms are used herein has sufficient compliance that, when compressed with a force of 100 pounds between two rigid, planar surfaces, it will be compacted, i.e., the two rigid planar surfaces will be able to move closer to one another, by an amount equal to at least ¼″. It is, however, an outstanding advantage of the preferred configuration described above that the maximum compaction is at or near the point P (more precisely, along or near the line joining all of the points P that are defined for all the cross-sections that can be taken through the cushion portion), and is less everywhere else, so along the line intersecting the point P the cushion portion will undergo a greater compaction, or elevational decrease, and therefore will provide more comfort, precisely where the most force is being applied.

As mentioned at the outset, the cushion portions are connected together by a strap 12. The strap 12 is “flexible,” meaning for purposes herein that it allows for moving one of the cushion portions 10a relative to the other, within the radius defined by the length of the strap, without encountering any significant resistance from the strap. The strap provides for maintaining the cushion portions 10a, 10b in close proximity, so that one of the cushion portions will not become lost; it ensures that the cushion portions are transported together; and it facilitates such transport by allowing the user to maintain a hold on the cushion 10 by holding onto the strap. At the same time, the strap allows freedom of relative movement of the two cushion portions within the defined radius, providing for an outstanding capability for the cushion 10 to be adjusted to suit the user and the meditative activity.

The strap 12 preferably allows for detaching the two cushion portions from one another if desired, such as by use of a snap-fit latch 13 as shown in FIG. 1; however, this is not essential. The strap could also be provided with two latches at the respective point of attachment to the cushion portions, allowing for the substantially complete removal of the strap from the seating cushion.

The strap 12 is long enough to allow the cushion portions to be deployed as described above. Where the strap is connected to the cushion portions at nearest corners of the cushion portions as shown in FIG. 1, the strap is preferably about 4″ long.

The strap may be formed of any polymeric and/or fibrous material, preferred materials being nylon, polyethylene, or hemp.

It is to be understood that, while a specific meditation seating cushion and use thereof has been shown and described as preferred, other configurations could be used, and other uses could be made, in addition to those already mentioned, without departing from the principles of the invention. For example, while being preferably provided for seated use in the practice of meditative activities, cushions and cushion portions according to the invention can be used to serve other support or comfort purposes such as resting, sleeping, and providing support needed as a result of injury or in the course of physical therapy.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A seating cushion for use in supporting a person in a seated position, comprising:
a first cushion portion;
a second cushion portion separate from said first cushion portion; and
a strap connecting said first and second cushion portions together.

2. The seating cushion of claim 1, wherein the cushion portions are substantially identical in size and shape.

3. The seating cushion of claim 2, wherein one of said cushion portions has a substantially planar bottom surface having one or more edges defining a perimeter thereof, and a top surface opposed to said bottom surface, and wherein said top surface has an elevation that varies relative to said bottom surface, and more particularly, with reference to a first reference plane perpendicular to said bottom surface and intersecting said perimeter at left and right edge-points thereof, with said first reference plane defining a first reference line lying in the plane of said bottom surface, said elevation varies in said first reference plane so as to have a left edge value defined at said left edge-point, a right edge value defined at said right edge-point, and a peak value defined at an intermediate point on said first reference line lying between said left and right edge-points, and so as to decrease monotonically from said peak value to said left and right edge values.

4. The seating cushion of claim 3, wherein the minimum difference between said peak value and either of said left and right edge values is about 1.5″

5. The seating cushion of claim 4, wherein said top surface has a substantially constant radius of curvature in said first reference plane.

6. The seating cushion of claim 3, wherein said top surface has a substantially constant radius of curvature in said first reference plane.

7. The seating cushion of claim 3, wherein, with reference to a second reference plane which intersects said perimeter at respective fore and aft edge-points thereof, and which defines a second reference line lying in the plane of said bottom surface, wherein the distance between said fore and aft edge-points defines a length of the cushion portion, and with reference to any number of third reference planes parallel to said first reference plane and intersecting said second reference line at intermediate points thereof which are spaced from said fore and aft edge-points at least an amount equal to 25% of said length, each of said third reference planes intersecting said perimeter at corresponding left and right edge-points thereof and defining a corresponding third reference line lying in the plane of said bottom surface, said elevation varies in any of said third reference planes so as to have a respective left edge value defined at the respective left edge-point, a respective right edge value at the respective right edge-point, and a respective peak value defined at a respective intermediate point on the respective third reference line lying between the respective left and right edge-points, and so as to decrease monotonically from the respective peak value to the respective left and right edge values.

8. The seating cushion of claim 7, wherein, for any of said third reference planes, the minimum difference between the respective peak value and either of the respective left and right edge values is 1.5″.

9. The seating cushion of claim 8, wherein said top surface has a substantially constant radius of curvature that is substantially the same in each of said third reference planes.

10. The seating cushion of claim 7, wherein said top surface has a substantially constant radius of curvature that is substantially the same in each of said third reference planes.

11. The seating cushion of claim 8, wherein said one cushion portion has bilateral symmetry about said second reference plane.

12. The seating cushion of claim 7, wherein said one cushion portion has bilateral symmetry about said second reference plane.

13. The seating cushion of claim 4, wherein said one cushion portion has bilateral symmetry about a second reference plane which is perpendicular to both the plane of said bottom surface and said first reference plane.

14. The seating cushion of claim 3, wherein said one cushion portion has bilateral symmetry about a second reference plane which is perpendicular to both the plane of said bottom surface and said first reference plane.

15. The seating cushion of claim 2, wherein said cushion portions each have bilateral symmetry.

16. A method for seating a person, comprising:
providing a first cushion portion and a second cushion portion separate from the first cushion portion;
disposing the first cushion portion under one of the buttocks of the person; and
disposing the second cushion under the other buttocks of the person.

17. The method of claim 16, further comprising spacing the first and second cushion portions apart from one another.

18. The method of claim 17, wherein the first and second cushion portions each have, respectively, a substantially planar bottom surface, the method further comprising disposing both of said bottom surfaces on a horizontal support surface.

19. The method of claim 16, wherein the first and second cushion portions each have, respectively, a substantially planar bottom surface, the method further comprising disposing both of said bottom surfaces on a horizontal support surface.

20. The method of claim 19, wherein the cushion portions are substantially identical in size and shape and the seated person defines a plane of bilateral symmetry, the method further comprising disposing the two cushion portions so that they are symmetrically disposed about said plane.

21. The method of claim 20, wherein the cushion portions each have a substantially straight line of maximum elevation, the method further comprising disposing the cushion portions so that infinitely extending lines collinear with said lines of maximum elevation define an angle therebetween of between about 10 and 35 degrees, and intersect behind the seated person.

22. The method of claim 18, wherein the cushion portions are substantially identical in size and shape and the seated person defines a plane of bilateral symmetry, the method further comprising disposing the two cushion portions such that they are symmetrically disposed about said plane.

23. The method of claim 22, wherein the cushion portions each have a substantially straight line of maximum elevation, the method further comprising disposing the cushion portions so that infinitely extending lines collinear with said lines of maximum elevation define an angle therebetween of between about 10 and 35 degrees, and intersect behind the seated person.

24. The method of claim 17, wherein the cushion portions are substantially identical in size and shape and the seated person defines a plane of bilateral symmetry, the method further comprising disposing the two cushion portions such that they are symmetrically disposed about said plane.

25. The method of claim 24, wherein the cushion portions each have a substantially straight line of maximum elevation, the method further comprising disposing the cushion portions so that infinitely extending lines collinear with said lines of maximum elevation define an angle therebetween of between about 10 and 35 degrees, and intersect behind the seated person.

26. The method of claim 16, wherein the cushion portions are substantially identical in size and shape and the seated person defines a plane of bilateral symmetry, the method further comprising disposing the two cushion portions such that they are symmetrically disposed about said plane.

27. The method of claim 26, wherein the cushion portions each have a substantially straight line of maximum elevation, the method further comprising disposing the cushion portions so that infinitely extending lines collinear with said lines of maximum elevation define an angle therebetween of between about 10 and 35 degrees, and intersect behind the seated person.

28. The method of claim 16, wherein the cushion portions are connected by a strap, further comprising manually carrying the two cushion portions at least partially with the aid of said strap.
